(19) United States
(12) Patent Application Publication
(10) Pub. No.: US 2012/0141963 A1
(43) Pub. Date: Jun. 7, 2012

(54) DEVICE AND METHOD FOR PROVIDING MEDICAL INFORMATION

(76) Inventor: Harpreet Singh, Grand Rapids, MI (US)

(21) Appl. No.: 12/957,701

(22) Filed: Dec. 1, 2010

(51) Int. Cl. G09B 23/28; B65D 85/00

(52) U.S. Cl. 434/262; 206/459.5

(57) ABSTRACT

A device and method for providing medical information to patients admitted in health care facilities such as hospitals, comprising a container with medical information relating to a medical condition provided on a display panel thereof, wherein the container can be used to store and transport a patient's personal items, wherein the container and medical information thereon is provided to the patient upon admission to the health care facility, the patient is educated regarding the information during the course of the patient's stay, and the patient is encouraged to take the container upon discharge from the facility.

### CROSS-REFERENCE TO RELATED APPLICATIONS

Not Applicable.

### BACKGROUND OF THE INVENTION

The invention is in the field of a device for providing medical information to patients, and a method therefor.

### BRIEF SUMMARY OF THE INVENTION

The invention comprises a device for providing medical information to a patient, and a method therefor, wherein the device comprises a container having a display with medical information for the patient, preferably in the form of an easy to understand and recall checklist, and most preferably in the form of a mnemonic for the patient to use and also having a size and shape sufficient to hold common personal items or items commonly provided by the hospital to the patient upon discharge.

In use, the device is placed in the patient's room, in a location which is visible or accessible to the patient upon admission of the patient to the hospital; the patient is educated using the information provided thereon during the patient's stay; and the device is then sent home with the patient when the patient is discharged.

### BRIEF DESCRIPTION OF THE DRAWINGS

FIG. 1 is a side perspective view of the container device for providing medical information to patients;

FIG. 2 is a side perspective view of the container device in use; and

FIG. 3 is flow chart showing the process of using the device to provide medical information to patients.

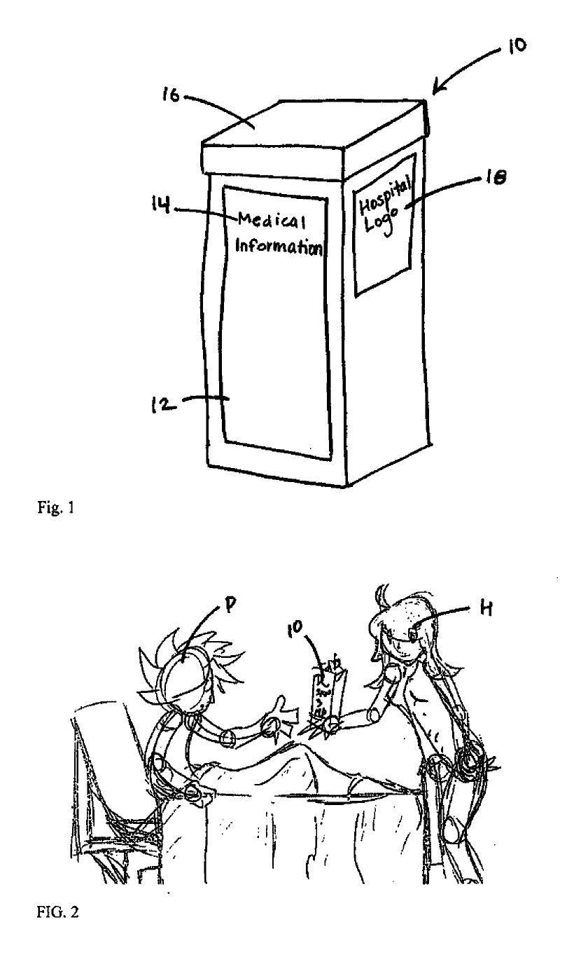

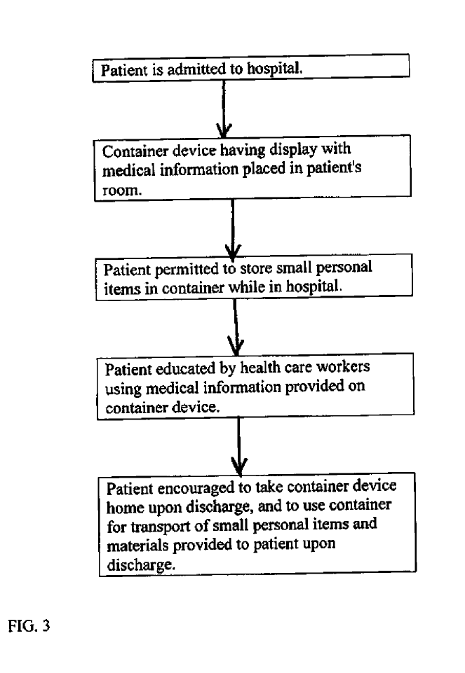

### DETAILED DESCRIPTION OF THE PREFERRED EMBODIMENTS

One preferred embodiment of the container device 10 described herein includes a container device 10, with display panel 12 having medical information 14, wherein medical information 14 is presented in an easy to remember format such as a checklist. The checklist is preferably presented in the form of a mnemonic, to encourage patient recall.

Patients P in hospitals are often provided with discharge instructions within only the last half hour of their stay in a hospital. Patients P are often distracted during the final minutes of their stay, may have a ride waiting to take them home. Patients P typically have poor recall of information provided during these last moments of a hospital stay, and may not have time to sufficiently internalize the information or ask follow up questions that they may have.

Container device 10 is sized to hold common patient items, such as eye glasses, jewelry, medications, preferably in child-proof containers, or other small personal items or discharge instructions that patents P may have when they are admitted to the hospital or upon discharge from the hospital. A removable or hingedly connected lid 16 is provided to keep contents such as those described herein safely stowed within container 10.

The container device 10 also provides a location to provide information to the patient regarding the hospital or care facility itself. For example, a preferred container provides a second display area 18 for branding of the hospital or doctors group, in addition to the display 12 providing medical information 14 to the patient. The container device 10 is sent with the patient upon discharge, and therefore patient P will have the information readily available, even when patient P returns home.

Displays 12 and 18 may be located in any convenient location on the container, preferably on the outside thereof for easy access by the patient P without having to open container 10.

Medical information 14, including checklists and mnemonics, tailored to a specific patient population can optionally be used based on the population of patients P to be treated in a hospital facility or portion thereof, including but not limited to adults, children, new mothers, or patients suffering from particular conditions or illnesses. Particularly with respect to adult hospital patients in the general population, certain conditions, such as heart failure or diabetes, are predominant and interlinked with other complaints that a patient may have, and therefore information on these conditions may be useful to a significant percentage of a given patient population. Due to its prevalence and large number of incidences of readmission following a hospital stay, educating all patients in the signs and symptoms of heart failure may ultimately improve health and reduce admissions among all a broad patient population, even those who were not admitted with heart failure as a primary complaint.

One preferred mnemonic for use with respect to heart failure is “Dr. Saw3MD,” which can be further written out as DR. SAW SAW SAW THREE MD. This mnemonic stands for the following:

TABLE 1
Mnemonic for patient checklist

| Mnemonic | Description |
|---|---|
| DR | Follow up with doctor |
| SAW | Symptoms, Activity and Weight |
| SAW | Salt and Water |
| SAW | Smoking, Alcohol and Wine |
| T | Tests to be followed |
| H | Health Insurance; Home health nursing |
| R | Resources for the family |
| E | Equipment (walker, cane, oxygen, beds, glucometer, scale) |
| E | Expert in giving injections |
| M | Medications |
| D | Diet |

Readmission rates to hospitals are high, especially for patients suffering from heart failure and related diseases. The likelihood of readmission is increased for patient P if patient P does not understand or follow the discharge instructions provided to patient P. The method described herein is to assist patient P in understanding and internalizing the steps to be taken to reduce the likelihood of readmission for heart failure and related illnesses.

The container device 10 described herein preferably would not include personally identifiable information on its exterior, such as personal health information protected under the Health Insurance Portability and Accountability Act (“HIPAA”) or other federal law. This would help to minimize the risk of displaying such personal or protected information.

Preferably, to use the container device 10 described herein, a method comprising the following steps is used: (1) the device 10 is placed in the room of patient P upon admission, preferably within view of patient P from the hospital bed; (2) patient P is educated by health care providers H regarding the medical information 14 presented on the device during the course of time while patient P is admitted; and (3) patient P is encouraged to take device 10 home following discharge.

To further encourage patients P to keep and use device 10, personal items of patient P or items normally provided by the hospital, such as follow up information, discharge instructions, or containers having medications can be placed in the container device 10 for easy transport by patient P.

Providing the patient with sufficient time to review and understand medical information 14 and discharge instructions will increase patient confidence and satisfaction, as patients P will leave the hospital with a clearer understanding of the follow up care and warning signs that they will need to monitor in order to prevent readmission. The extended time with post-discharge medical information will also allow patients P to organize and arrange their affairs for when the patients P return home following discharge. For example, a patient P will have an increased length of time to organize for any home care assistance that may be necessary upon discharge.

Using the container device 10 and patient education method described herein encourages consistent and early communication between the patient P and the health care providers H who provide care in the hospital setting, allowing a consistent, clear and easy to remember message to be provided to patient P.

Of course it is understood that the above is a description of preferred embodiments, and that various changes and alterations can be made to the container device 10 or method of educating patients using the same without departing from the spirit and broader aspects of the invention.

What is claimed is:

1. A patient educating device for use in health care facilities, comprising:
a container, and
a display panel on the exterior of the container, wherein the display panel contains medical information relating to at least one medical condition for use in educating patients.

2. The patient educating device of claim 1, wherein the container has a size and shape sufficient to carry small personal items of the patient.

3. The patient educating device of claim 1, wherein the container has a size and shape sufficient to carry discharge instructions and other small items frequently provided to the patient upon discharge from a health care facility.

4. The patient educating device of claim 1, wherein the display panel contains medical information in the form of a checklist of issues for the patient.

5. The patient educating device of claim 4, wherein the checklist is represented by a mnemonic.

6. The patient educating device of claim 5, wherein at least one medical condition described in the medical information is heart failure.

7. The patient educating device of claim 5, wherein at least one medical condition described in the medical information is diabetes.

8. The patient educating device of claim 1, further comprising a second display panel having the name or logo of the health care facility.

9. A method of educating patients comprising the steps of:
Placing the container device of claim 1 in a patient's room upon admission of the patient to the medical facility;
Encouraging the patient to take the container device home upon discharge from the medical facility.

10. The method of claim 9, further comprising the step of educating the patient regarding the medical information on the display panel of the container device during the course of the patient's stay in the medical facility.

11. The method of claim 10, wherein the step of educating the patient occurs over a period of more than 1 day.

12. The method of claim 10, wherein the step of educating the patient is performed by more than one care provider.

13. The method of claim 9, wherein the patients’ personal effects are placed inside the container device during the patient's stay in the medical facility.

14. The method of claim 9, wherein the patients' personal effects are placed inside the container prior to discharging the patient from the medical facility.

15. The method of claim 9, wherein any materials provided by the medical facility upon discharge of the patient are placed inside the container prior to discharging the patient from the medical facility.

16. The method of claim 15, wherein the materials comprise discharge instructions.

17. The method of claim 15, wherein the materials comprise prescription medications.
